(19) United States
(12) Patent Application Publication
(10) Pub. No.: US 2026/0171761 A1
(43) Pub. Date: Jun. 18, 2026

(54) Powerwall Apparatus and Method for Operation thereof

(71) Applicant: Ian Clague, Bournemouth (GB)

(72) Inventor: Ian Clague, Bournemouth (GB)

(21) Appl. No.: 19/074,751

(22) Filed: Mar. 10, 2025

(30) Foreign Application Priority Data
Dec. 13, 2024 (GB) 2418324.6

(51) Int. Cl. H02B 1/20; H02J 4/00

(52) U.S. Cl. CPC H02B 1/20; H02J 4/00; H02J 2105/12

(57) ABSTRACT

There is provided a powerwall apparatus configured to be installed onto a building. The powerwall apparatus includes an enclosure including one or more modules. A control module controls operation of the powerwall apparatus, for controlling energy generation occurring within the powerwall apparatus, for controlling energy storage occurring within the powerwall apparatus, and for controlling energy flow occurring within the powerwall apparatus, as well as externally into the powerwall apparatus and out of the powerwall apparatus. An inverter module is used for converting voltages and a format of power flows occurring in the powerwall apparatus for matching requirements of the one or more modules. An energy storage module is used for storing energy within the apparatus. An energy converter module is used for converting or generating power based on electron-positron interactions occurring within one or more optical devices. The apparatus is configured for power flows to occur therein when in operation.

### CROSS-REFERENCES TO RELATED APPLICATIONS

This Non-Provisional Patent Application claims the benefit of and priority to United Kingdom Patent Application Serial No. GB 2418324.6, filed Dec. 13, 2024, entitled “Powerwall Apparatus and Method for Operation thereof,” the entire contents of which are hereby incorporated herein by reference.

### BACKGROUND

The present disclosure relates to powerwall apparatus that are configured to provide energy management and supply within buildings, for example within residential buildings, within apartment buildings, within manufacturing facility buildings and such like. Moreover, the present disclosure relates to methods for using aforesaid powerwall apparatus for managing energy flows and energy storage within aforesaid buildings. Furthermore, the present disclosure relates to software products stored on a data carrier, wherein the software products are executable on computing hardware for implementing the aforesaid methods.

Powerwall apparatus is known; for example, Tesla® manufactures a powerwall apparatus including rechargeable batteries, at least one inverter apparatus and a power management control unit. The known powerwall apparatus is configured to be installed onto a given building, for example onto an exterior-facing wall surface of a residential building. Moreover, the known powerwall apparatus is optionally configured to connect to renewable energy apparatus of the given building to receive power therefrom; for example, the renewable energy apparatus may include one or more solar photovoltaic panels configured to receive sunlight. Furthermore, the known powerwall apparatus optionally includes connections for charging electric vehicles, for example Tesla® Cybertrucks®. Additionally, the known powerwall apparatus optionally includes an external grid connection for connecting a local power network of the given building to a utility power grid.

The power management control unit is configured to control power flows taken from the external grid, an amount of power stored within the rechargeable batteries, an amount of power extracted from the rechargeable batteries, and when the power flows are permitted to occur; for example, the power management control unit will prioritize using energy from the renewable energy apparatus to save an owner of the known firewall having to extract energy from the utility power grid. The power management control unit is configurable to execute various algorithms that may assist to support the utility grid by supplying power thereto (for example, during periods of high demand on the grid), to receive power from the grid (for example, at times when tariffs are inexpensive) and to buffer energy supply for charging the electric vehicle when fast charging is required.

A problem that is encountered with the known powerwall apparatus, especially when connected to the renewable energy apparatus, is that power delivery therefrom may be very variable, depending on weather conditions and time-of-day. Moreover, the rechargeable batteries may become depleted of charge when required to supply power back to the utility grid for prolonged periods of time. Moreover, in an event of power from the utility grid becoming unavailable, for example in a “black out”, the rechargeable batteries are only capable of providing power for a finite period before becoming discharged.

The present disclosure seeks to address shortcoming and problems encountered with known powerwall apparatus, for example described above.

### SUMMARY

According to a first aspect, there is provided a powerwall apparatus as defined in appended claim 1.

According to a second aspect, there is provided a method for operating the powerwall apparatus of the first aspect, wherein the method is defined in appended claim 10.

According to a third aspect, there is provided a software product recorded on a machine-readable data carrier, wherein the software product is executable on computing hardware for implementing the method of the second aspect.

Embodiments of the present disclosure are of advantage in that they include an energy converter that functions to provide power input to the powerwall apparatus to assist its operation.

### BRIEF DESCRIPTION OF THE DRAWINGS

Embodiments of the present disclosure will be described with reference to the following diagrams, wherein:

FIG. 1 is an illustration of a building that has a powerwall apparatus of the present disclosure attached thereto, wherein the powerwall apparatus is configured to supply energy to the building, for example from a power grid, from a renewable energy apparatus and from an energy converter included in the powerwall apparatus;

FIG. 2 is a more detailed illustration of the powerwall apparatus of FIG. 1;

FIG. 3 is an illustration of a method for operating the powerwall apparatus of FIG. 2;

FIG. 4A is a schematic plan-view illustration of an energy converter of the present disclosure, wherein the energy converter includes a photon bifurcation region A, a biasing region B, an acceleration region C, and an energy harvesting region D

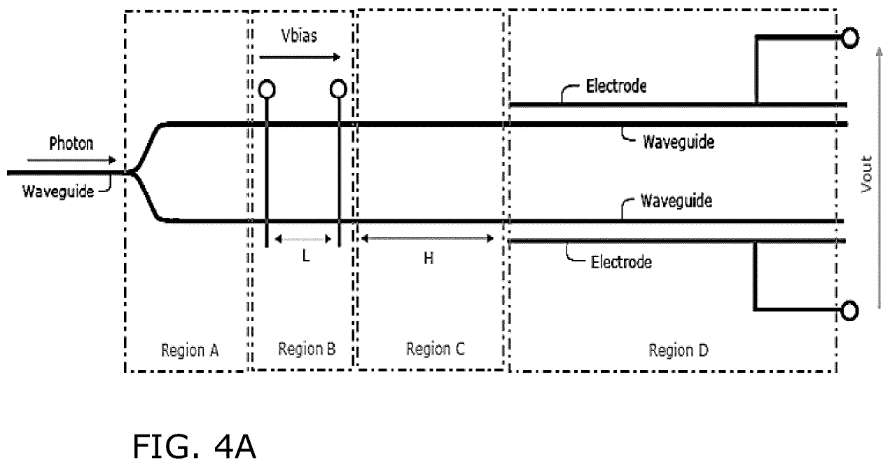

FIG. 4B is an alternative implementation of the energy converter of FIG. 4A, wherein the region B and the region C are spatially coincident;

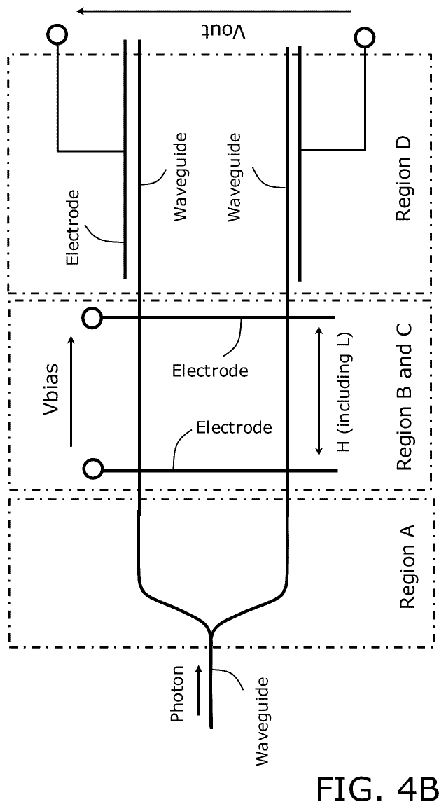

FIG. 5 is an illustration of forces occurring between matter and anti-matter that break symmetry of Newton's Third Law of Motion, as reported in the Pei et al. citation; the forces are used in the energy converter of FIGS. 4A, 4B; and

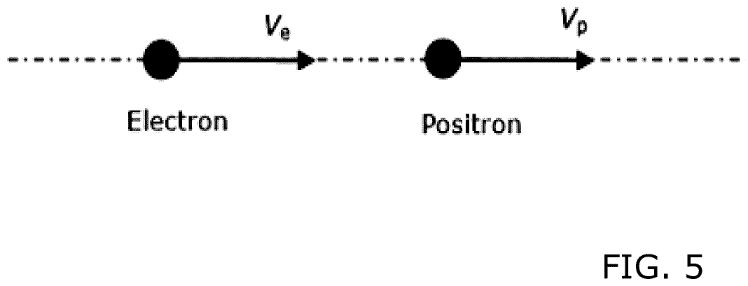

FIG. 6 is an illustration of steps of a method for operating the energy converter of FIGS. 4A, 4B.

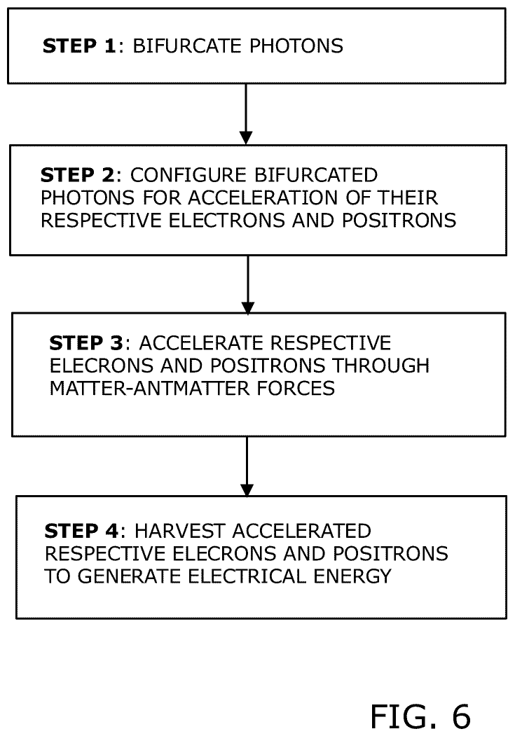

### DETAILED DESCRIPTION

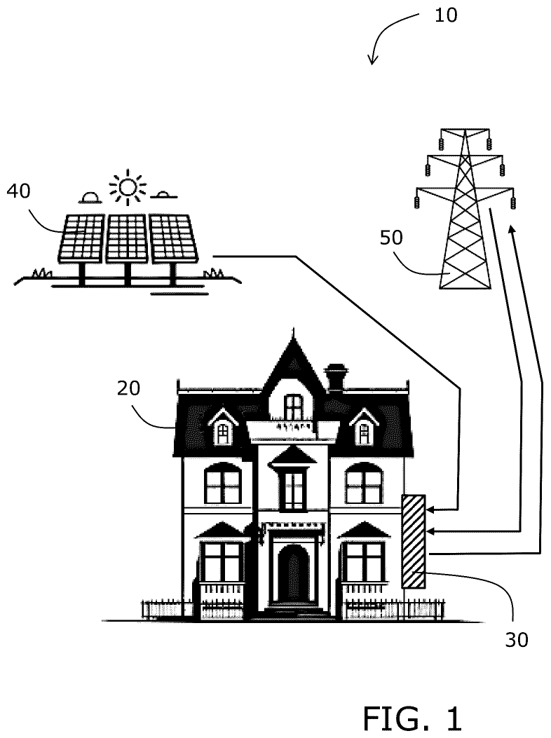

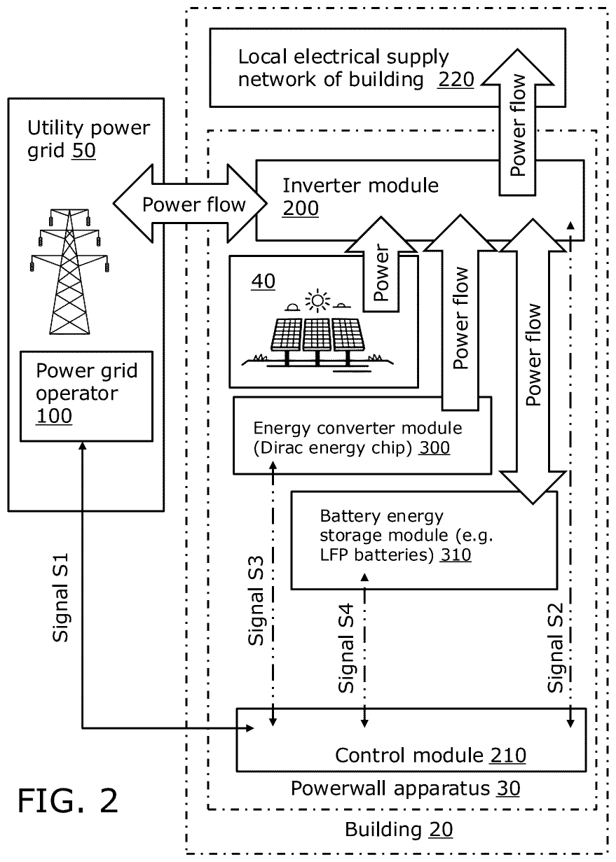

Referring to FIGS. 1 and 2, there is shown an illustration of a configuration 10 including a building 20, for example a residential house, with its associated optional renewable energy apparatus 40; for example, the renewable energy apparatus 40 is implemented as a photovoltaic solar panel arrangement, for example an array of solar photovoltaic panels mounted to a roof of the building 20. The configuration 10 also includes a powerwall apparatus 30 attached to the building 20; for example, the powerwall apparatus 30 is mounted to an exterior-facing surface of an exterior wall of the building 20. The powerwall apparatus 30 is connected to a local electrical supply network 220 of the building 20.

The powerwall apparatus 30 is also connected to a utility power grid 50 for receiving power therefrom. For example, the power grid 50 includes at least one of: nuclear power generators, wind turbine generators, photovoltaic solar array generators, coal-fired power generators, oil-fired power generators, gas-powered generators, hydroelectric power generators, geothermal power generators, tidal power generators, ocean wave power generators, but not limited thereto. The utility power grid 50 is configured to be managed by a power grid operator 100 that is configured to provide a signal S1 indicative of a status of the utility power grid 50; for example, the signal S1 may provide an indication of a real-time balance between aggregate generating capacity of the utility power grid 50, and power load applied to the utility power grid 50, wherein the building 20 potentially contributes to the applied power load when receiving power from the utility power grid 50.

The powerwall apparatus 30 is implemented within a planar enclosure, for example 1 metre tall ×2 metres wide×10 cm thick planar metal box; beneficially, the planar enclosure is at least partially fire-proof. Moreover, optionally as aforementioned, the planar enclosure may be mounted to a wall of the building 20 using a mounting bracket. During installation, the bracket is secured to a given wall of the building 20, and then the planar enclosure is mounted onto the bracket. Furthermore, the planar enclosure is configured to house various modules affixed to a rear inside wall of the planar enclosure. The planar enclosure beneficially includes a front access door or moveable panel that allows personnel access to the various modules. Beneficially, there are provided cable holes, for example secure via sealing grommets, on a lower edge of the planar enclosure. The planar enclosure is conveniently manufactured from one or more metals, from plastics material, from Carbon fibre composite materials, from fibreglass composite materials and so forth; however, other materials may be optionally used for manufacturing the enclosure. Beneficially, the planar enclosure includes fire retardant materials for safety. Optionally, the powerwall apparatus 30 includes a fan arrangement for cooling an inside of the planar enclosure in an event that its internal temperature exceeds a threshold temperature.

The various modules of the powerwall apparatus 30 include a control module 210, an inverter module 200, a battery energy storage module 310 and an energy converter 300, referred to as a “Dirac powerchip module”. These modules 210, 220, 310 are electrically interconnected within the planar enclosure of the powerwall apparatus 30. Moreover, the various modules are optionally connected directly or indirectly to the external utility electrical power grid 50, and to the optional renewable energy apparatus 40. Optionally, the optional renewable energy apparatus 40 includes one or more local renewable energy devices such as roof-top mounted solar photovoltaic panels, as aforementioned. The control module 210 includes control signals S2, S3 and S4 for controlling operation of the inverter module 200, the energy converter 300, respectively.

The energy converter 300 is a very important part of the powerwall apparatus 30, wherein the energy converter 300 is described in great detail in APPENDIX 1 and APPENDIX 2, included below.

The control module 210 includes at least one microcontroller including computing hardware that is configured in use to execute one or more software products for controlling operation of the powerwall apparatus 30. Moreover, the control module 210 beneficially includes a communication arrangement, for example an Internet-of-Things (IoT) communication device; for example, the communication device includes a wireless connection, an optical fibre communication network link and such like. The communication arrangement enables the control module 210 to receive external commands, for example the signal S1 from the power grid operator 100. Moreover, the signal S1 may be bi-directional for the powerwall apparatus 30 to provide a report of a status or power consumption of the local electrical supply network 220 to which the powerwall apparatus 30 is connected to provide power thereto, for example an electrical power circuit of the aforesaid building 20 as aforementioned.

The battery energy storage module 310 beneficially includes a configuration of one or more rechargeable batteries, for example one or more rechargeable Lithium Iron Phosphate batteries, Sodium salt rechargeable batteries or solid-state batteries. Optionally, the one or more rechargeable batteries are supplemented by one or more ultracapacitors or supercapacitors for coping more effectively with transient power surges encountered in operation by the powerwall apparatus 30. Beneficially, the control module 210 is configured to function as a battery management system for the battery energy storage module 310, to reduce a risk of overcharging the one or more rechargeable batteries or over-discharging the one or more rechargeable batteries. The battery management system monitors terminal voltages of the one or more rechargeable batteries, and power flows to and from the one or more batteries, thereby monitoring a state of charge of the one or more rechargeable batteries and also detecting any long-term changes in operation of the one or more rechargeable batteries that is indicative of a potential fault developing in the one or more rechargeable batteries.

The inverter module 200 includes semiconductor switching devices and high-frequency ferrite transformers for enabling power flows to occur between at least one of the utility power grid 50 and the renewable energy apparatus 40 to the powerwall apparatus 30, for example to the battery energy storage module 310 arrangement and to the energy converter module 300 (including “Dirac power chip”). The inverter module 200 is configured to convert power in d.c. form to corresponding power in a.c. form, and vice versa; such form is referred as being a “format” elsewhere in this description. In operation, the inverter module 200 converts electrical power provided from one of the modules 300, 310 and the renewable energy apparatus 40 at a first voltage and delivers the electrical power to another of the modules at a second voltage. Moreover, the inverter module 200 also converts input power received from the utility power grid 50 into a form suitable for supplying to one or more of: the local electrical power supply network 220, and to the battery energy storage module 310. Furthermore, optionally, the inverter module 200 also converts power present within the powerwall apparatus 30 into a form suitable to feed onto the utility power grid 50, for example, in an event that the powerwall apparatus 30 is supplying (for example, selling) locally-produced power to the utility power grid 50; for example, power generated by the energy converter module 310 module is supplied, when demand arising in the building 20 is low, for example at night time.

In operation, at least one of the battery energy storage module 310, the optional renewable energy apparatus 40, and the utility power grid 50 are used to provide power to kick-start operation of the energy converter module 300 (“Dirac powerchip”), for example under supervision of the control module 210.

The energy converter module 300 (including “Dirac powerchip”) is used to provide power to the powerwall apparatus 30. The energy converter module 30 may be used to recharge the battery energy storage module 310 when power demand on the local electrical supply network 220 is low, saving cost by avoiding a need to recharge the battery energy storage module 310 from the utility power grid 50. It will be appreciated that the energy converter module 300 is assisted by the battery energy storage module 310 to cope with fluctuating power demand, for example power surges, occurring from the local electrical supply network 220.

It will be appreciated that the powerwall apparatus 30 may be used in “stand-alone” mode to provide power to the building 20, without there being a need to connect the powerwall apparatus 30 to the external utility supply power grid 50, for example in a situation of remote buildings in rural locations (namely, “off-grid” operation) or in an event of a major long-term failure of the external utility supply power grid 50.

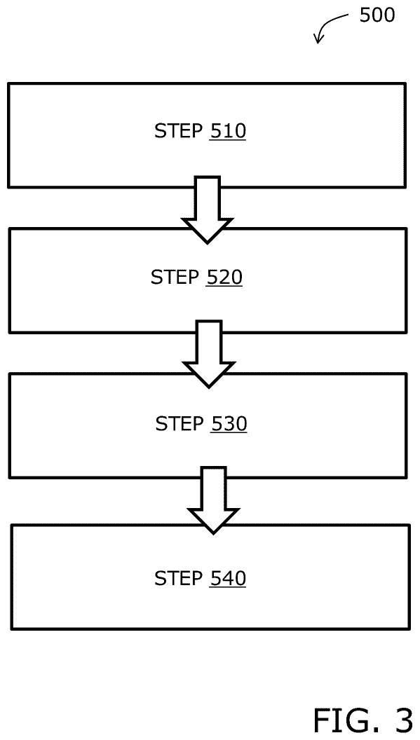

Referring next to FIG. 3, a flow chart is indicated generally by 500. The flow chart 500 includes a series of steps 510, 520, 530 and 540. Moreover, the flow chart 500 relates to a method for operating the powerwall apparatus 30.

The method 500 relates to using the aforesaid powerwall apparatus 30 installed onto a wall of the building 20 for providing electrical power to the building 20, wherein the powerwall apparatus 30 includes the aforesaid enclosure into which are mounted the one or more modules 200, 210, 300, 310; the one or more modules 200, 210, 300, 310 include: the control module 210 for controlling operation of the powerwall apparatus 30, for controlling energy generation occurring within the powerwall apparatus 30, for controlling energy storage occurring within the powerwall apparatus 30, and for controlling energy flow occurring within the powerwall apparatus 30, as well as externally into the powerwall apparatus 30 and out of the powerwall apparatus 30. Moreover, the powerwall apparatus 30 includes the inverter module 200 for converting voltages and format (for example, a.c., d.c.) of power flows occurring in the powerwall apparatus 30 for matching requirements of the one or more modules 200, 210, 300, 310. Furthermore, the powerwall apparatus 30 includes the energy storage module 310 for storing energy within the powerwall apparatus 30. Additionally, the powerwall apparatus 30 includes energy converter module 300, wherein the energy converter module 300 is optionally configured to function as an energy generating module, for generating power based on electron-positron interactions occurring within one or more optical devices.

The method 500 includes:
the step 510 for configuring the powerwall apparatus 30 for power flows to occur therein when in operation;
the step 520 for optionally configuring the powerwall apparatus 30 to receive power from the utility power grid 50 to contribute to the power flows of the step 510;
the step 530 for optionally configuring the powerwall apparatus 30 to deliver power to the utility power grid 50 derived from the power flows within the powerwall apparatus 30; and
the step 540 for configuring the powerwall apparatus 30 to deliver power to the local electrical power network 220 of the building 20.

### STATEMENTS

Statement 1: An energy converter for converting photons into electrical energy, wherein the energy converter is implemented as an integrated circuit in which the photons propagate in a coherent manner, wherein the energy converter includes a configuration of waveguides and electrodes that are configured to receive the photons, at least partially bifurcate the photons into their respective electrons and positrons, configure the at least partially bifurcated electrons and positrons so that they mutually accelerate to provided accelerated electrons and positrons, and harvest the accelerated electrons and positrons to generate the electrical energy.

Statement 2: An energy converter of Statement 1, wherein the integrated circuit is implemented as a Lithium Niobate photonic integrated circuit or a Lithium-Niobate-On-Insulator photonic integrated circuit.

Statement 3: An energy converter of Statement 1 or 2, wherein the waveguides are fabricated from an optically non-linear material that is configured to exhibit in use a non-linear optical characteristic.

Statement 4: An energy converter of Statement 1, 2 or 3, wherein the waveguides are implemented in an array of mutually parallel elongate waveguides.

Statement 5: An energy converter of Statement 1, 2, 3 or 4, wherein the energy converter includes a biasing and acceleration region (regions B and C) therein, wherein the biasing and acceleration region is configured to apply an electric field to the positrons and electrons to cause them to be configured to mutually accelerate to gain energy, wherein the electric field is orientated with its electric field vector substantially parallel to elongate axes of the waveguides along which the electrons and positrons propagate.

Statement 6: a method for operating an energy converter for converting photons into electrical energy,
wherein the energy converter is implemented as an integrated circuit in which the photons propagate in a coherent manner, wherein the energy converter includes a configuration of waveguides and electrodes that are configured to receive the photons,
wherein the method includes:
   (i) using the energy converter to at least partially bifurcate the photons into their respective electrons and positrons;
   (ii) configuring the at least partially bifurcated electrons and positrons so that they mutually accelerate to provided accelerated electrons and positrons; and
   (iii) harvesting the accelerated electrons and positrons to generate the electrical energy.

Statement 7: A method of Statement 6, wherein the method includes using a biasing and acceleration region to apply an electric field to the positrons and electrons to cause them to be configured to mutually accelerate to gain energy, wherein the electric field is orientated with its electric field vector substantially parallel to elongate axes of the waveguides along which the electrons and positrons propagate.

Statement 8: A photonics module including an energy converter of Statement 1 together with a laser arrangement including one or more lasers configured in use to generate photons for the energy converter to convert to electrical power.

1. A powerwall apparatus configured to be installed onto a building, wherein the powerwall apparatus includes an enclosure into which are mounted one or more modules, wherein the one or more modules include:
a control module for controlling operation of the powerwall apparatus, for controlling energy generation occurring within the powerwall apparatus, for controlling energy storage occurring within the powerwall apparatus, and for controlling energy flow occurring within the powerwall apparatus, as well as externally into the powerwall apparatus and out of the powerwall apparatus;
an inverter module for converting voltages and a format of power flows occurring in the powerwall apparatus for matching requirements of the one or more modules;
an energy storage module for storing energy within the powerwall apparatus; and
an energy converter module for generating or converting power based on electron-positron interactions occurring within one or more optical devices,
wherein the powerwall apparatus is configured for power flows to occur therein when in operation;
wherein the powerwall apparatus is configured optionally to receive power from a utility power grid to contribute to the power flows;
wherein the powerwall apparatus is configured optionally to deliver power to the utility power grid derived from the power flows within the powerwall apparatus; and
wherein the powerwall apparatus is configured to deliver power to a local electrical power network of the building.

2. The powerwall apparatus of claim 1, wherein the powerwall apparatus is configured to be mounted onto the wall of the building.

3. The powerwall apparatus of claim 2, wherein the format of power flow includes: direct current (d.c.), alternating current (a.c.).

4. The powerwall apparatus of claim 3, wherein the energy converter module is configured for converting photons into electrical energy, wherein the energy converter module is implemented as an integrated circuit in which the photons propagate in a coherent manner, wherein the energy converter module includes a configuration of waveguides and electrodes that are configured to receive the photons, at least partially bifurcate the photons into their respective electrons and positrons, configure the at least partially bifurcated electrons and positrons so that they mutually accelerate to provide accelerated electrons and positrons, and harvest the accelerated electrons and positrons to generate the electrical energy.

5. The powerwall apparatus of claim 4, wherein the integrated circuit is implemented as a Lithium Niobate photonic integrated circuit or a Lithium-Niobate-On-Insulator photonic integrated circuit.

6. The powerwall apparatus of claim 5, wherein the waveguides are fabricated from an optically non-linear material that is configured to exhibit in use a non-linear optical characteristic.

7. The powerwall apparatus of claim 6, wherein the waveguides are implemented in an array of mutually parallel elongate waveguides.

8. The powerwall apparatus of claim 7, wherein the energy converter includes a biasing and acceleration region therein, wherein the biasing and acceleration region is configured to apply an electric field to the positrons and electrons to cause them to be configured to mutually accelerate to gain energy, wherein the electric field is orientated with its electric field vector substantially parallel to elongate axes of the waveguides along which the electrons and positrons propagate.

9. A method for using a powerwall apparatus installed onto a building for providing electrical power to the building, wherein the powerwall apparatus includes an enclosure into which are mounted one or more modules, wherein the one or more modules include:
a control module for controlling operation of the powerwall apparatus, for controlling energy generation occurring within the powerwall apparatus, for controlling energy storage occurring within the powerwall apparatus, and for controlling energy flow occurring within the powerwall apparatus, as well as externally into the powerwall apparatus and out of the powerwall apparatus;
an inverter module for converting voltages and a format of power flows occurring in the powerwall apparatus for matching requirements of the one or more modules;
an energy storage module for storing energy within the powerwall apparatus (30); and
an energy converter module for generating power based on electron-positron interactions occurring within one or more optical devices,
wherein the method includes:
configuring the powerwall apparatus for power flows to occur therein when in operation; and
configuring the powerwall apparatus to deliver power to a local electrical power network of the building.

10. The method of claim 9, wherein the energy converter module is configured for converting photons into electrical energy, wherein the energy converter module is implemented as an integrated circuit in which the photons propagate in a coherent manner, wherein the energy converter module includes a configuration of waveguides and electrodes that are configured to receive the photons, at least partially bifurcate the photons into their respective electrons and positrons, configure the at least partially bifurcated electrons and positrons so that they mutually accelerate to provide accelerated electrons and positrons, and harvest the accelerated electrons and positrons to generate the electrical energy.

11. The method of claim 9, further comprising configuring the powerwall apparatus to receive power from a utility power grid to contribute to the power flows.

12. The method of claim 9, further comprising configuring the powerwall apparatus to deliver power to the utility power grid derived from the power flows within the powerwall apparatus.

13. One or more hardware-based non-transitory memory devices storing computer-executable instructions disposed in a computing device, wherein the computing device is in communication with:
a control module for controlling operation of the powerwall apparatus, for controlling energy generation occurring within the powerwall apparatus, for controlling energy storage occurring within the powerwall apparatus, and for controlling energy flow occurring within the powerwall apparatus, as well as externally into the powerwall apparatus and out of the powerwall apparatus;
an inverter module for converting voltages and a format of power flows occurring in the powerwall apparatus for matching requirements of the one or more modules;
an energy storage module for storing energy within the powerwall apparatus; and
an energy converter module for generating power based on electron-positron interactions occurring within one or more optical devices,
wherein, when the instructions are executed by one or more processors disposed in the computing device, cause the computing device to:
configure the powerwall apparatus for power flows to occur therein when in operation; and
configure the powerwall apparatus to deliver power to a local electrical power network of the building.

14. The one or more hardware-based memory devices of claim 13, wherein the executed instructions further cause the computing device to configure the powerwall apparatus to receive power from a utility power grid to contribute to the power flows.

15. The one or more hardware-based memory devices of claim 13, wherein the executed instructions further cause the computing device to configure the powerwall apparatus to deliver power to the utility power grid derived from the power flows within the powerwall apparatus.
